(19) United States
(12) Patent Application Publication
(10) Pub. No.: US 2006/0261268 A1
(43) Pub. Date: Nov. 23, 2006

(54) Pattern measuring system and semiconductor device manufacturing method

(76) Inventor: Tadashi Mitsui, Kamakura-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/403,998

(22) Filed: Apr. 14, 2006

(30) Foreign Application Priority Data
Apr. 15, 2005 (JP) 2005-118518

(51) Int. Cl. G21K 7/00

(52) U.S. Cl. 250/310

(57) ABSTRACT

A pattern measuring system comprises an image database provided independently of an image obtaining apparatus, which obtains an image of pattern to be evaluated, and storing the image data, which is obtained by the image obtaining apparatus, and the additional information of the image data; and an image measuring computer provided independently of the image obtaining apparatus and measuring the image data stored in the image database, wherein the image data stored in the image database is measured by the image measuring computer using a measurement recipe selected based on the additional information of the image data, and the result of measurement is sent to a host computer.

### CROSS-REFERENCE TO RELATED APPLICATION

This application is based upon and claims the benefit of priority from the prior Japanese Patent Application No. 2005-118518, filed on 15 Apr. 2005; the entire contents of which are incorporated herein by reference.

### BACKGROUND OF THE INVENTION

1. Field of the Invention

The present invention relates to a pattern measuring system for measuring a pattern in a manufacturing process, that is, in in-line and to a semiconductor device manufacturing method of measuring a pattern using the pattern measuring system.

2. Background Art

Conventionally, dimensions are measured using, for example, a CD SEM (Critical Dimension Scanning Electron-beam Microscope) as a measuring apparatus to inspect the shape of a semiconductor pattern formed on a semiconductor substrate (wafer) in a semiconductor manufacturing process such as a lithography process, an etching process, and the like.

In the conventional CD SEM, obtaining the image of pattern to be evaluated and measuring the image data of the obtained image are continuously performed (that is, to evaluation of the pattern of a semiconductor by analyzing the image data). The result of evaluation of the semiconductor pattern is sent to a host computer (production management system) that determines whether or not the pattern is acceptable. In this case, measurement of the image is performed by an EWS (Engineering Workstation) that belongs to the CD SEM, and the like. Further, there is a case that the image data of a SEM image obtained by the CD SEM is stored in a recording media such a MO and the like and an image measurement processing is performed in a separate computer. However, this is solely conducted by an engineer for the purpose of obtaining experiment data to develop a process and is not an in-line measurement for managing production.

In general, although a user selects a CD SEM by comprehensively assessing performance, price, reliability, and the like, the user can evaluate an image only by a measuring method provided by the manufacturer of the CD SEM. Accordingly, in order to evaluate a pattern by a method required by the user as described above, a problem arises in that the user must store the image output from a CD SEM and measure it by an additional computer in off-line.

Furthermore, CD SEMs of different manufactures cannot obtain the same value to the same pattern even if they measure a simplest line width CD. This is mainly because that the respective manufacturers employ different pattern measuring methods in addition to that the images obtained by the CD SEMs are different in quality. When, for example, a threshold value method is used as the pattern measuring method, since the respective manufacturers subject an image to a different preprocessing and use a different internal processing parameter, the same result of measurement of the image cannot be obtained by the threshold value method. As described above, there is a problem in that the CD SEMs of different manufactures cannot be used in parallel with each other.

Furthermore, recently, necessity for measuring the shape of a pattern in addition to a simple measurement of CD is increased. However, when measurement is more complex as in the measurement of a pattern shape, more time will be necessary for performing the measurement by an EWS that belongs to an CD SEM. As described above, the conventional measuring systems have a problem in that an increase in a time necessary to measurement decreases the number of images that can be recorded in a unit time with a result that the throughput of semiconductor devices is deteriorated.

### SUMMARY OF THE INVENTION

According one aspect of the present invention, there is provided: a pattern measuring system comprises an image database provided independently of an image obtaining apparatus, which obtains an image of pattern to be evaluated, and storing the image data, which is obtained by the image obtaining apparatus, and the additional information of the image data; and an image measuring computer provided independently of the image obtaining apparatus and measuring the image data stored in the image database, wherein the image data stored in the image database is measured by the image measuring computer using a measurement recipe selected based on the additional information of the image data, and the result of measurement is sent to a host computer.

According second aspect of the present invention, there is provided: a semiconductor device manufacturing method performed by a pattern measuring system which comprises an image obtaining apparatus for obtain the image of pattern to be evaluated, an image database provided independently of the image obtaining apparatus to store the image data obtained by the image obtaining apparatus and the additional information of the image data, and an image measuring computer provided independently of the image obtaining apparatus, measures the image data stored in the image database through the image measuring computer using a measurement recipe selected based on the additional information of the image data, and sends the result of measurement to a host computer, the method comprising: measuring the pattern to be evaluated formed by a semiconductor device manufacturing process by the pattern measuring system; and determining a processing of a semiconductor substrate on which the pattern to be evaluated is formed based on the result of measurement or managing the manufacturing condition of a manufacturing process being evaluated.

### BRIEF DESCRIPTION OF THE DRAWINGS

FIG. 1 is a block diagram showing a pattern measuring system according to a first embodiment of the present invention;

FIG. 2 is a block diagram showing a pattern measuring system according to a second embodiment of the present invention;

FIG. 3 is a block diagram showing a pattern measuring system according to a third embodiment of the present invention;

FIG. 4 is a block diagram showing an example of image data to be measured by a distributed computing system of a pattern measuring system according to a fourth embodiment of the present invention; and

FIG. 5 is a block diagram showing the outline of the distributed computing system for processing the image data of FIG. 4.

### DETAILED DESCRIPTION

Embodiments according to the present invention provide pattern measuring systems that can automatically analyze the data of a measuring apparatus and directly send the result of evaluation of a pattern to a production management system. The embodiments to which the present invention is applied will be explained below.

### First Embodiment

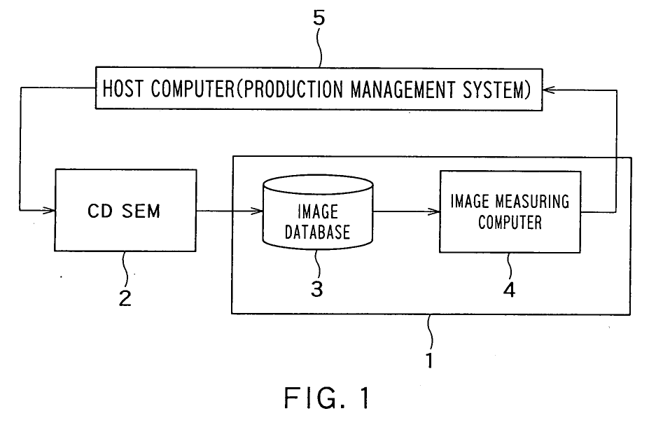

FIG. 1 is a block diagram showing a pattern measuring system according to a first embodiment of the present invention. It is to be noted that, in a conventional semiconductor manufacturing process, an image is measured after preset information such as lot information, a measuring condition, and the like is downloaded from a host computer to a CD SEM (Critical Dimension Scanning Electron-beam Microscope) as a measuring apparatus. However, in the embodiment, a CD SEM is used as an image obtaining apparatus for obtaining the image of pattern to be evaluated formed in a semiconductor manufacturing process.

The pattern measuring system 1 includes an image database 3, which is provided independently of the CD SEM 2 and stores the image data obtained by the CD SEM 2 as the image obtaining apparatus for obtaining the image of the pattern to be evaluated and additional information of the image data such as the lot information, the measurement condition, and the like, and an image measuring computer 4 which is provided independently of the CD SEM 2 and measures the image data stored in the image database 3.

A measurement agent, which is an automatic execution program residing in the pattern measuring system 1 at all times, issues a measurement processing request to the image data obtained by the CD SEM 2 to the image measuring computer 4. The measurement processing request indicates the image measuring computer 4 the measurement agent selects a measurement recipe by determining a previously registered measuring method based on the additional information of the image data.

When the image measuring computer 4 can execute a measurement processing in response to the measurement processing request as described above, it sequentially subjects the image data stored in the image database 3 by the selected measurement recipe based on the additional information of the image data. The image measuring computer 4 sends the result of measurement to, for example, an upper computer (not shown), and the upper computer received the result of measurement sends it to a host computer 5 as lot data when necessary.

The host computer 5 outputs the lot information, the measurement condition, and the like for measuring the image of the measuring pattern as well as also acts as a production management system for determining whether or not the pattern to be evaluated is acceptable based on the obtained result of measurement. Based on the determination of acceptability of the pattern to be evaluated, for example, eliminating an unacceptable lot (wafers as semiconductor substrates), subjecting the lot (wafers) to be evaluated to a processing again, managing the manufacturing condition and the like of a manufacturing process to be evaluated, and the like are performed. More specifically, how the wafers, on which the pattern to be evaluated is formed, are processed is determined based on the result of measurement performed by the pattern measuring system 1, and a semiconductor manufacturing process for manufacturing a semiconductor device is managed by the host computer 5 that manages the manufacturing process to be evaluated.

As described above, in the first embodiment according to the present invention, since the CD SEM 2 is used only to obtain the image of the pattern as well as the obtained image data is stored in the image database 3 provided independently of the CD SEM 2 when necessary, the CD SEM 2 can execute the image obtaining processing at a high speed.

Furthermore, the measurement agent as the automatic execution program monitors the image data and the additional information stored in the image database 3 from the CD SEM 2, automatically requests the image measuring computer 4 to execute measurement, and sends the result of measurement to the upper host computer, thereby the image measurement processing can be performed in in-line.

Furthermore, since the image is measured by the image measuring computer 4 provided independently of the CD SEM 2 used as the measuring apparatus, even if an image is obtained by a CD SEM of a different manufacturer (that is, by a CD SEM having a different specification as to a measuring method and the like), a difference of results of measurement can be reduced between measuring apparatuses because the same pattern measurement method is employed.

It is to be noted that the image measuring computer 4 may directly send the result of measurement to the host computer 5 as the lot data.

As described above, according to the pattern measuring system and the semiconductor device manufacturing method of the embodiment, it is possible to measure a pattern in in-line as well as to improve the throughput of semiconductor devices while permitting an image obtaining apparatus having a different specification to be used.

### Second Embodiment

In the first embodiment, the arrangement for directly sending the result of measurement from the image measuring computer to the upper computer or to the host computer is described. In a second embodiment, however, an arrangement, in which a result database is further provided to store the result of measurement, will be explained.

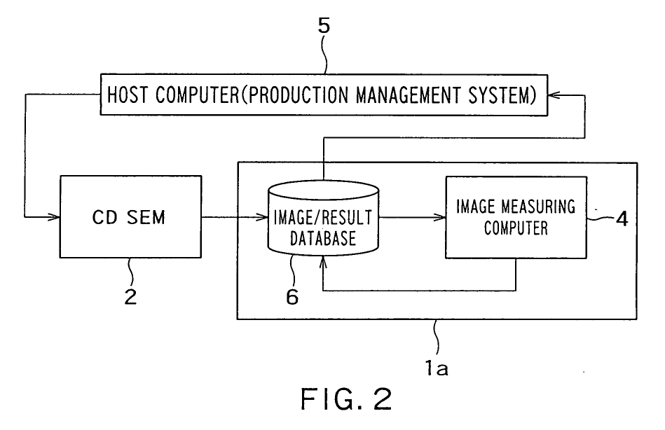

FIG. 2 is a block diagram showing a pattern measuring system according to the second embodiment of the present invention.

As shown in FIG. 2, the pattern measuring system la includes an image/result database 6, which is provided independently of the CD SEM 2 and stores the image data obtained by the CD SEM 2 and the additional information of the image data, and an image measuring computer 4 which is provided independently of the CD SEM 2 and measures the image data stored in the image/result database 6. It is to be noted that although the image/result database 6 is arranged such that an image database and a result database are formed in different regions in a single drive, the image database and the result database may be separately formed in separate drives or devices.

Likewise the first embodiment, a measurement agent issues an image data measurement processing request to the image measuring computer 4. The image measuring computer 4 measures the image data stored in a image database 3 by a measurement recipe selected based on the additional information of the image data. The result of measurement of the image data performed by the image measuring computer 4 using an automatic execution program residing in the pattern measuring system 1a at all times is stored in the image/result database 6. More specifically, the result of measurement is stored in a result of measurement field of an image record of the image/result database 6. With this operation, a load for storing the result of measurement in the image measuring computer 4, for example, can be reduced.

Furthermore, the result of measurement stored in the result database by the automatic execution program is sent to a host computer 5 through an upper computer (not shown) as lot data at a preset timing.

It is to be noted that although the image database and the result database are explained as the image/result database 6 integrated into one database in the second embodiment, they achieve the same operation/working effect even if they are arranged as separate databases.

As described above, according to the pattern measuring system of the second embodiment, a pattern can be measured in in-line as well as the throughput of semiconductor devices can be improved while permitting image obtaining apparatuses having a different specification to be used. Furthermore, since the pattern measuring system is provided with the image/result database for storing the result of measurement, it is possible to temporarily store the result of measurement and to send it to the upper computer or to the host computer at predetermined timing.

### Third Embodiment

In the arrangements of the embodiments 1, 2 described above, image data is directly stored in the image database from the CD SEM as the image obtaining apparatus. In an third embodiment, however, an arrangement having a server for temporarily storing image data obtained by the CD SEM will be explained.

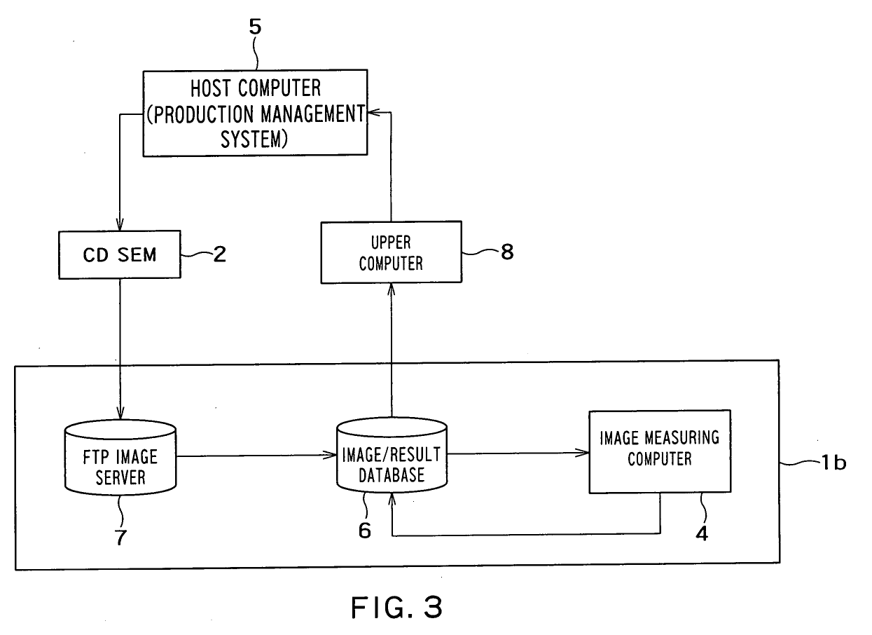

FIG. 3 is a block diagram showing a pattern measuring system according to the third embodiment of the present invention.

The pattern measuring system 1b includes an FTP (File Transfer Protocol) image server 7 for temporarily storing the image data obtained by the CD SEM 2 and the additional information of the image data, an image/result database 6, which is provided independently of the CD SEM 2 and stores the image data and the additional information of the image data that are stored temporarily, and an image measuring computer 4 which is provided independently of the CD SEM 2 and measure the image data stored in the image/result database 6.

When the image data obtained by the CD SEM 2 and the additional information of the image data are temporarily stored in the FTP image server 7, a JOB agent as an automatic execution program residing in the pattern measuring system 1b at all times detects that the image data is stored in the FTP image server 7 and stores the image data in an image/result database 6 together with the additional information. Since the thus obtained image data is stored in the FTP image server 7 provided independently of the CD SEM 2 when necessary, the image obtaining processing of the CD SEM 2 can be performed at high speed.

Likewise the second embodiment, a measurement agent issues an image data measurement processing request to the image measuring computer 4. The image measuring computer 4 measures the image data stored in the image/result database 6 by a measurement recipe selected based on the additional information of the image data. The result of measurement of the image data performed by the image measuring computer 4 using an automatic execution program residing in the pattern measuring system 1b at all times is stored in the image/result database 6.

Furthermore, the result of measurement stored in the image/result database 6 is sent as lot data to a host computer 5 through an upper computer 8 at preset timing by the automatic execution program acting as a result agent. It is to be noted that the result agent starts when, for example, it detects the operation of the JOB agent or the operation of the measurement agent.

It is to be noted that although the image database and the result database are explained as the image/result database 6 integrated into one database in the third embodiment likewise the second embodiment, they achieve the same operation/working effect even if they are arranged as separate databases.

As described above, according to the pattern measuring system of the third embodiment, a pattern can be measured in in-line as well as the throughput of semiconductor devices can be improved while permitting image obtaining apparatuses having a different specification to be used.

### Fourth Embodiment

Although the embodiments described above explain the arrangement using the image measuring computer to measure image data, a fourth embodiment described below explains an arrangement in which a distributed computing system is applied to the pattern measuring systems of the respective embodiments described above as an image measuring computer to measure image data in shorter time.

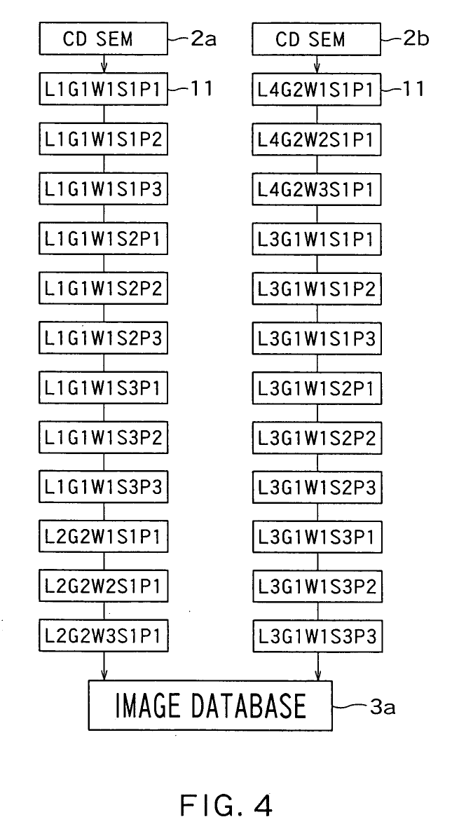

FIG. 4 is a block diagram showing an example of image data to be measured by the distributed computing system of a pattern measuring system according the fourth embodiment of the present invention.

As shown in FIG. 4, a plurality of pieces of image data 11 are obtained in parallel with each other by a first CD SEM 2a and a second CD SEM 2b as image obtaining apparatuses. The obtained image data 11 is sequentially sent to and stored in an image database 3a.

The obtained image data 11 is prescribed by a lot number (for example, lot No. L1), a process name (for example, gate process G1), a measuring wafer (for example, slot number W1), measuring sample (for example, shot No. S1), and a measuring point (for example, measuring point No. P1). With this arrangement, the image data 11 can be specified by being uniquely described as, for example, additional information L1G1W1S1P1.

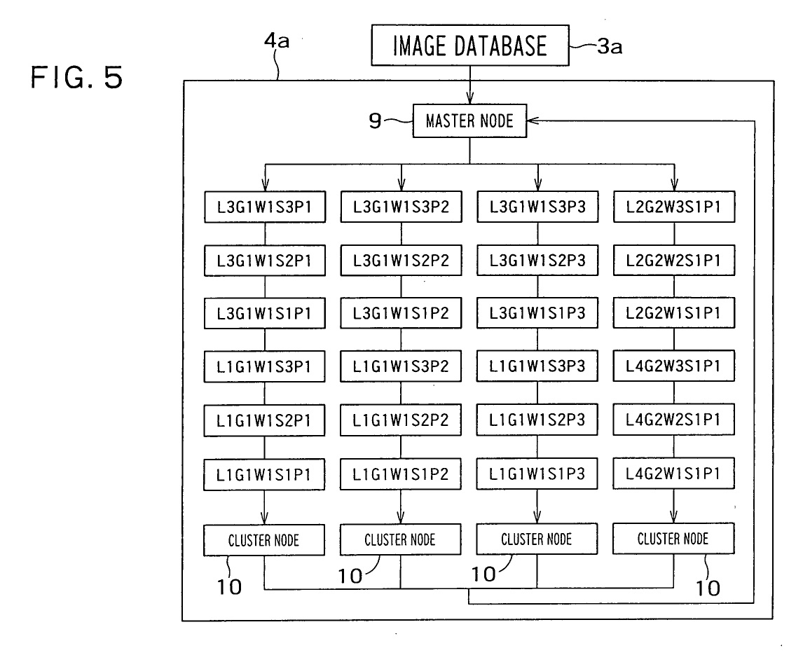

FIG. 5 is a block diagram showing the outline of distributed computing for processing the image data of FIG. 4.

As shown in FIG. 5, the image measuring computer according to the fourth embodiment is composed of a distributed computing system 4a having a master node 9 for classifying a plurality of pieces of image data stored in an image database 3a based on additional information and a plurality of cluster nodes 10 for measuring the respective classified pieces of the image data classified by the master node 9.

The master node 9 classifies the plurality of pieces of image data stored in the image database 3a or temporarily stored in an FTP image server based on the additional information after it rearranges the image data every measuring points (measuring point No. P1 to P3) at, for example, given intervals.

The cluster nodes 10 measure the classified image data in a predetermined condition using a measurement recipe selected based on the additional information. The result of measurement obtained by the measurement performed by the cluster nodes 10 is arranged to a predetermined order by the master node 9 and sent to a upper computer, a host computer as the output from the distributed computing system 4a, that is, from the image measuring computer or stored in a result database.

As described above, the plurality of pieces of image data obtained by the first and second CD SEMs 2a, 2b as the image obtaining apparatus is measured by the device combination system in parallel with each other. With this operation, when, for example, a template must be formed to execute the measuring processing, and the like, the efficiency of the measuring processing can be improved as well as a processing time of a lot can be reduced.

It is to be noted that although the case, in which the image data obtained by the first and second CD SEMs 2a, 2b is directly sent to the image database 3a, is explained in the fourth embodiment, the image data may be temporarily stored in the FTP image server likewise the third embodiment.

As described above, according to the pattern measuring system according to the fourth embodiment, it is particularly possible to improve the efficiency of the measuring processing as well as to reduce the processing time of each lot.

It is to be noted that although the case of executing CD measurement is explained in the respective embodiments, they can be also applied to the measuring processing of respective parameters when defective alignment and a film thickness are measured in a semiconductor production line. Furthermore, the embodiments can be also applied to a measuring system for measuring a line width of a transistor in a TFT (Thin Film Transistor) liquid crystal panel production line and other measuring processings.

What is claimed is:

1. A pattern measuring system comprising:
an image database provided independently of an image obtaining apparatus, which obtains an image of pattern to be evaluated, and storing the image data, which is obtained by the image obtaining apparatus, and the additional information of the image data; and
an image measuring computer provided independently of the image obtaining apparatus and measuring the image data stored in the image database,
wherein the image data stored in the image database is measured by the image measuring computer using a measurement recipe selected based on the additional information of the image data, and the result of measurement is sent to a host computer.

2. A pattern measuring system according to claim 1, further comprising:
a result database provided independently of the image obtaining apparatus and storing the result of measurement measured by the image measuring computer,
wherein the result of measurement obtained by the image measuring computer is stored in the result database, and the result of measurement stored in the result database is sent to the host computer at predetermined timing.

3. A pattern measuring system according to claim 2, further comprising:
a FTP image server for temporarily storing the image data obtained by the image obtaining apparatus and the additional information of the image data;
wherein the image data temporarily stored in the FTP image server and the additional information of the image data are stored in the image database.

4. A pattern measuring system according to claim 1,
wherein the image measuring computer comprises a distributed computing system having a master node for classifying a plurality of pieces of image data stored in the image database based on the additional information and a plurality of cluster nodes for measuring the respective classified pieces of the image data classified by the master node,
wherein the plurality of pieces of image data obtained by the image obtaining apparatus are measured by the distributed computing system in parallel with each other.

5. A pattern measuring system according to claim 1, wherein the image obtaining apparatus is a CD SEM.

6. A semiconductor device manufacturing method performed by a pattern measuring system which comprises an image obtaining apparatus for obtain the image of pattern to be evaluated, an image database provided independently of the image obtaining apparatus to store the image data obtained by the image obtaining apparatus and the additional information of the image data, and an image measuring computer provided independently of the image obtaining apparatus, measures the image data stored in the image database through the image measuring computer using a measurement recipe selected based on the additional information of the image data, and sends the result of measurement to a host computer, the method comprising:
measuring the pattern to be evaluated formed by a semiconductor device manufacturing process by the pattern measuring system; and
determining a processing of a semiconductor substrate on which the pattern to be evaluated is formed based on the result of measurement or managing the manufacturing condition of a manufacturing process being evaluated.

7. The semiconductor device manufacturing method according to claim 6, wherein pattern measuring system further comprising a result database provided independently of the image obtaining apparatus and storing the result of measurement measured by the image measuring computer,
wherein the result of measurement obtained by the image measuring computer is stored in the result database, and the result of measurement stored in the result database is sent to the host computer at predetermined timing.

8. The semiconductor device manufacturing method according to claim 7, wherein pattern measuring system further comprising a FTP image server for temporarily storing the image data obtained by the image obtaining apparatus and the additional information of the image data;
wherein the image data temporarily stored in the FTP image server and the additional information of the image data are stored in the image database.

9. The semiconductor device manufacturing method according to claim 6, wherein the image measuring computer comprises a distributed computing system having a master node for classifying a plurality of pieces of image data stored in the image database based on the additional information and a plurality of cluster nodes for measuring the respective classified pieces of the image data classified by the master node,
wherein the plurality of pieces of image data obtained by the image obtaining apparatus are measured by the distributed computing system in parallel with each other.

10. The semiconductor device manufacturing method according to claim 6, wherein the image obtaining apparatus is a CD SEM.
